(19) United States
(12) Patent Application Publication
(10) Pub. No.: US 2003/0076283 A1
(43) Pub. Date: Apr. 24, 2003

(54) Method and apparatus for reducing dynamic false contour in plasma display panel

(75) Inventors: Yao-Hung Lai, Taipei (TW); Chun-Hsu Lin, Taipei (TW); Ching-Hui Lin, Taipei (TW)

Correspondence Address: BACON & THOMAS, PLLC, 625 SLATERS LANE, FOURTH FLOOR, ALEXANDRIA, VA, 22314

(73) Assignee: CHUNGHWA PICTURE TUBES, LTD., Taipei (TW)

(21) Appl. No.: 09/983,453

(22) Filed: Oct. 24, 2001

(51) Int. Cl. G09G 3/28

(52) U.S. Cl. 345/60; 345/63

(57) ABSTRACT

A method for reducing dynamic false contour in a plasma display panel (PDP) comprises the steps of selecting some gray scales of different visual concentration series from all of gray scales available to be shown on said PDP to form a conversion table, converting original input value of gray scale of each discharge unit into corresponding selected gray scales having the same value of gray scale via said conversion table, and showing said corresponding selected gray scales on discharge units corresponding to each sub-field of each field, in order to average visual concentration difference between gray scales of two adjacent discharge units on the dynamic field into a smaller one.

### FIELD OF THE INVENTION

The present invention relates to plasma display panels (PDPs) and more particularly to a method and apparatus for reducing dynamic false contour in plasma display panel.

### BACKGROUND OF THE INVENTION

Conventionally, an image shown on PDP is generated by a control circuit which is enabled to control the number of sustain pulses of red (R), green (G), blue (B) discharge cells of each constituent pixel of PDP based on image data. Hence, gray scale of image may be shown in pixel. This means that color of each pixel is a mixture of brightness and associated color continuously generated by cells. Hereinbelow throughout the specification an image shown on PDP is defined as a field. In general, a continuous sustain pulse of a field on typical PDP is distributed to several sub-fields as shown in FIG. 1. The number of sustain pulses of one sub-field is different from that of the other one. In showing a field on PDP, gray scale represented by each cell is a combination of gray scales of all constituent sub-fields based on data of image to be shown. An exemplary example of gray scales of all sub-fields is as follows:

SF0:SF1:SF2:SF3:SF4:SF5:SF6:SF7=1:2:4:8:16:32:64:128

However, frequently there is a contour phenomenon caused by interlaced gray scales on portions of image while dynamically showing image on the typical PDP. Such phenomenon is called dynamic false contour. As understood that dynamic false contour may greatly reduce quality of image shown on PDP. Referring to FIG. 2, two continuous dynamic images are exemplified to discuss dynamic false contour wherein two adjacent cells have gray scales of 127 and 128 respectively. In detail, PDP utilize a time division technique to control number of sustain pulses of each cell for showing various gray scales (FIG. 1). Also, eyes of viewer may move as image moves. Hence, a trace of the dynamic image is generated on each point of retina. As a result, each point on retina may track image having different gray scales (FIG. 2). Referring to FIG. 3, hence when viewer watches two continuous dynamic scenes having gray scales of 127 and 128 on two adjacent cells respectively, gray scale of 127 will be sensed by R0 and R1 points of retina with respect to one cell, gray scale of 128 will be sensed by R3 and R4 points of retina with respect to the other cell, and gray scale of 0 will be sensed by R2 point of retina with respect to both cells (i.e., no gray scale) respectively. It is seen that there is a significant drop of sensed gray scale from R1 to R2 and from R2 to R3 with respect to scene represented by two adjacent cells respectively. For image sensed by eyes, interlaced gray scales (i.e., intermittent contour) occur on border between two adjacent cells having gray scales 127 and 128 respectively. This is so-called dynamic false contour.

For further explaining dynamic false contour a coefficient of visual concentration is defined below by PDP designers and manufacturers:

coefficient of visual concentration=(t1m1+t2m2+t3m3+ . . . )/(m1+m2+m3)

, where m1, m2, m3, . . . are weights of sub-fields and t1, t2, t3, . . . are time from beginning to midpoint during sustain period in each sub-field. This is best illustrated in FIG. 4. In view of above calculated coefficient, it is found that when visual concentrations of gray scales of two adjacent cells are proximate dynamic false contour does not tend to occur. Hence, by analyzing coefficient of visual concentration between two adjacent cells on PDP those skilled in the art may employ a suitable technique to solve the dynamic false contour based on variation therebetween. In the disclosure of Japanese Patent Laid-open Publication No. 8-270,869 two sets of different coefficients of visual concentration are utilized to exhibit gray scale of each gray scale on PDP by a following technique wherein parameters and corresponding number of continuous sustain pulses are defined with respect to each cell:

SF0:SF1:SF2:SF3:SF4:SF5:SF6:SF7=1:2:4:8:16:24:32:40

Hence, on PDP as for two sets of coefficient of visual concentration gray scale of 39 is exhibited, i.e.

1+2+4+8+24=39; and 1+2+4+32=39

Similarly, as for three sets of coefficient of visual concentration gray scale of 40 is exhibited, i.e.:

8+32=40; 16+24=40; and 40=40

In view of above patent, gray scale exhibited on PDP may be one of multiple sets of coefficient of visual concentration having different combinations as shown in FIG. 5. For solving dynamic false contour it is possible of dividing gray scales having different combinations into two sets of gray scale having different coefficients of visual concentration (e.g., A and B series) based on visual concentration. Further, an average value is obtained from visual concentrations of the sets of gray scale. The average value is taken as a parameter for solving dynamic false contour. As a result, visual concentration difference of gray scale between two adjacent cells is reduced. Referring to FIG. 6, adjacent pixels can exhibit gray scales having sets of different coefficients of visual concentration on PDP as disclosed by the above patent. As a result, visual concentration is more average for substantially eliminating dynamic false contour. In brief, such technique may smooth visual concentration and generate less obvious dynamic false contour. However, as understood that various gray scales exhibited by cells of PDP are determined by the number of discharge. Hence, it is disadvantageous for the discharge of PDP by utilizing two sets of gray scale having different coefficients of visual concentration to exhibit gray scale on each cell.

Thus, it is desirable to provide a method and apparatus for reducing dynamic false contour in PDP by error diffusion algorithm in order to overcome the above drawbacks of prior art.

### SUMMARY OF THE INVENTION

It is an object of the present invention to provide a method for reducing dynamic false contour in a plasma display panel (PDP) comprising the steps of selecting some gray scales of different visual concentration series from all of gray scales available to be shown on said PDP to form a conversion table, converting original input value of gray scale of each discharge unit (i.e. cells or pixels) into corresponding selected gray scales having the same value of gray scale via said conversion table, and showing said converted gray scales on corresponding discharge units corresponding to each sub-field of each field, in order to average visual concentration difference between gray scales of two adjacent discharge units on the dynamic field into a smaller one.

In one aspect of the present invention, visual concentration of different value of gray scale shown by any two adjacent discharge units on the dynamic field is averaged to obtain a value of gray scale having a smaller visual concentration difference. This can substantially eliminate dynamic false contour on PDP due to larger visual concentration difference.

It is another object of the present invention to provide an apparatus for reducing dynamic false contour in a plasma display panel (PDP) having a plurality of discharge units. The apparatus comprises a multiplexer as a data selector in showing dynamic image on the PDP. The multiplexer acts to determine the current output field based on vertical synchronous signals and timing pulse signals received by a control circuit. The multiplexer also selects a corresponding field from multiple sets of input fields of different visual concentration series generated by visual concentration conversion table. Next, the multiplexer outputs the selected one to a display circuit for driving each discharge unit. Thereafter, fields are shown on the PDP. As an end, in showing continuous field on the PDP visual concentration of different values of gray scale shown by any two of adjacent discharge units can be averaged to obtain one having smaller visual concentration difference.

The above and other objects, features and advantages of the present invention will become apparent from the following detailed description taken with the accompanying drawings.

### BRIEF DESCRIPTION OF THE DRAWINGS

FIG. 1 is a diagram showing a relationship of cells versus corresponding parameters during sustain period within a time span for showing a sub-field;

FIG. 2 is a graph showing a trace generated on each point of retina versus gray scale exhibited on adjacent cells when eyes of viewer move as two continuous scenes move on a conventional PDP;

FIG. 3 is a graph showing a relationship of sensed gray scales and points of retina with respect to the FIG. 2 image;

FIG. 4 is a graph showing periods of time from beginning to midpoint during sustain period on different cells;

FIG. 5 is a graph illustrating a technique disclosed by Japanese Patent Ad Laid-open Publication No. 8-270,869 for adjusting visual concentration by utilizing two sets of different coefficients of visual concentration;

FIG. 6 is a graph showing a distribution of adjacent pixels exhibited by gray scales having sets of different coefficients of visual concentration on PDP of the FIG. 5;

FIG. 7 is a graph showing distribution of values of gray scale, where in two continuous fields values of gray scale of two different visual concentration series are used to adjust the whole visual concentration according to a first preferred embodiment of the invention;

FIG. 8 is a graph showing distribution of values of gray scale, where on any two adjacent discharge units having different value of gray scale in a continuous field values of gray scale of three different visual concentration series are used to adjust the whole visual concentration according to the invention;

FIG. 9 is a graph showing distribution of values of gray scale, where in two continuous fields values of gray scale of two different visual concentration series are used to adjust the whole visual concentration according to a second preferred embodiment of the invention; and

FIG. 10 is a block diagram showing electrical components according to above preferred embodiments of the invention.

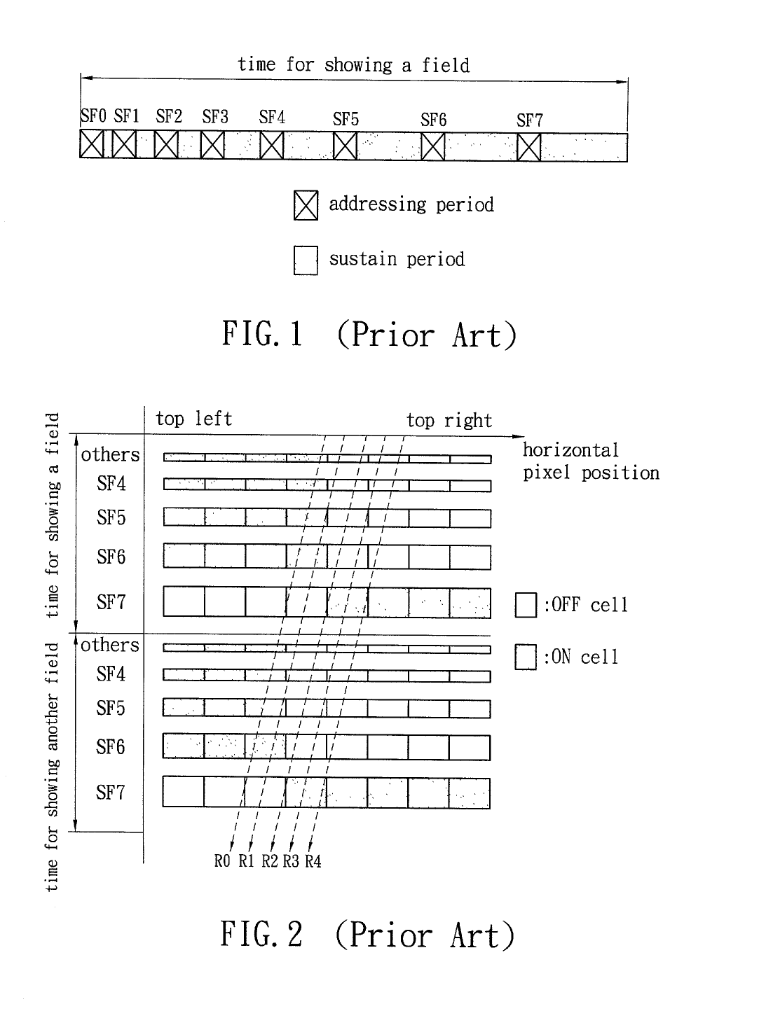

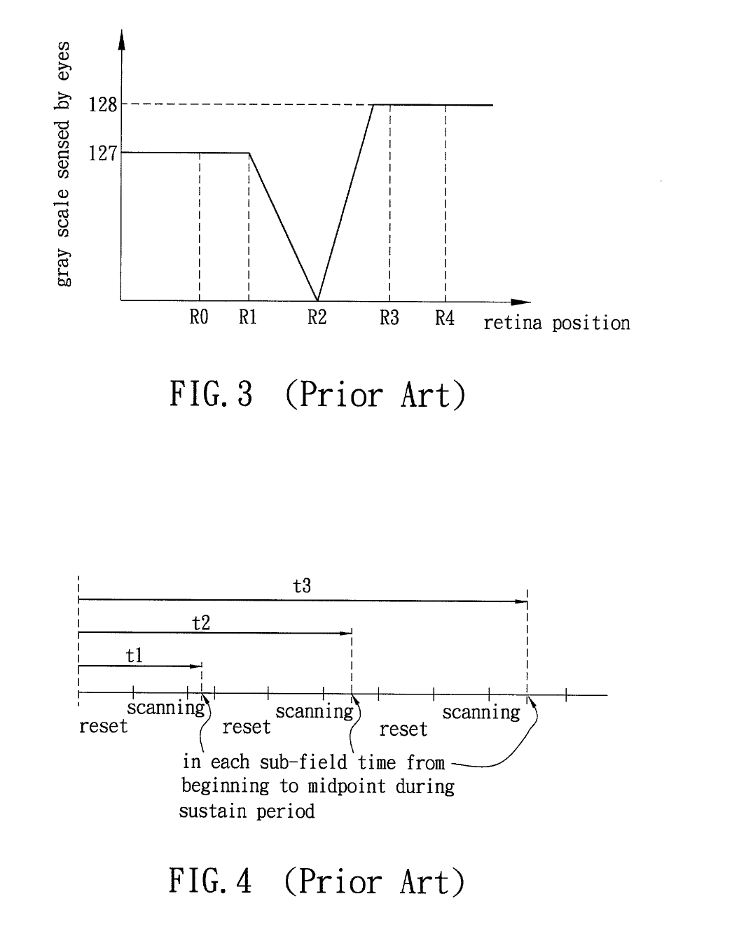

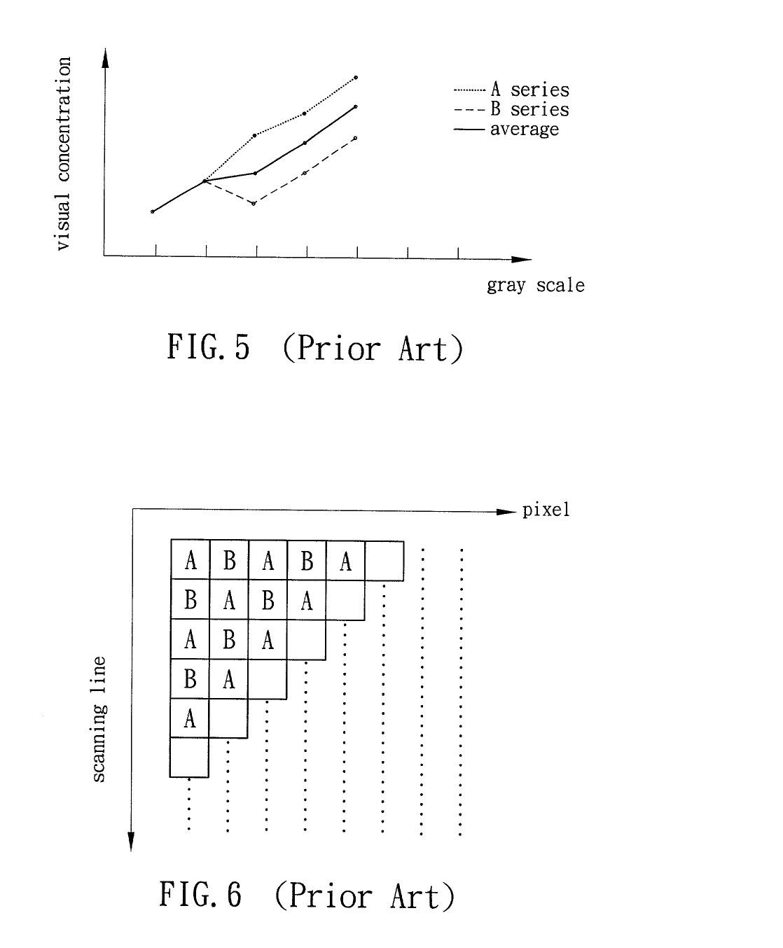

### DETAILED DESCRIPTION OF THE PREFERRED EMBODIMENTS

Typically, eyes of human being cannot distinguish variation of gray scale of discharge units (i.e. cells or pixels) of PDP as watching dynamic scenes on PDP. This is because a series of gray scales exhibited by units of PDP has been combined to form an image having brightness and color acceptable to eyes while watching. In other words, brightness and color observed by eyes are simply combinations of the series of gray scales of unit. This means that gray scale of any one of units is affected by gray scales of adjacent units. Moreover, in showing a field on PDP, discharge cell corresponding to each sub-field of field shows a predetermined value of gray scale based on the defined number of sustain pulses. Also, value of gray scale may have more than one visual concentration series depending on different number of sustain pulses of discharge cell corresponding to each sub-field. Hence, in showing a value of gray scale on a dynamic field of PDP, the same values of gray scale of different visual concentration series are shown on the continuously changed field. As a result, values of gray scale of each field are not adversely affected.

By utilizing this principle, the invention employs a visual concentration conversion table on PDP for converting the same input value of gray scale of each discharge unit into different visual concentration series having the same value of gray scale in showing each field of a dynamic image. Hence, in the process of dynamically showing a field, discharge unit corresponding to each sub-field of each field may show the same value of gray scale based on the number of sustain pulses corresponding to value of gray scale of different visual concentration series. In such a manner, for value of gray scale shown by two adjacent discharge units on the dynamic field it is shown as the same value of gray scale of different visual concentration series in the process of showing the continuous dynamic field. By utilizing the method of the invention, value of gray scale shown by any two adjacent discharge units is averaged to obtain a value of gray scale having a smaller visual concentration difference. This can substantially eliminate dynamic false contour on PDP due to larger visual concentration difference.

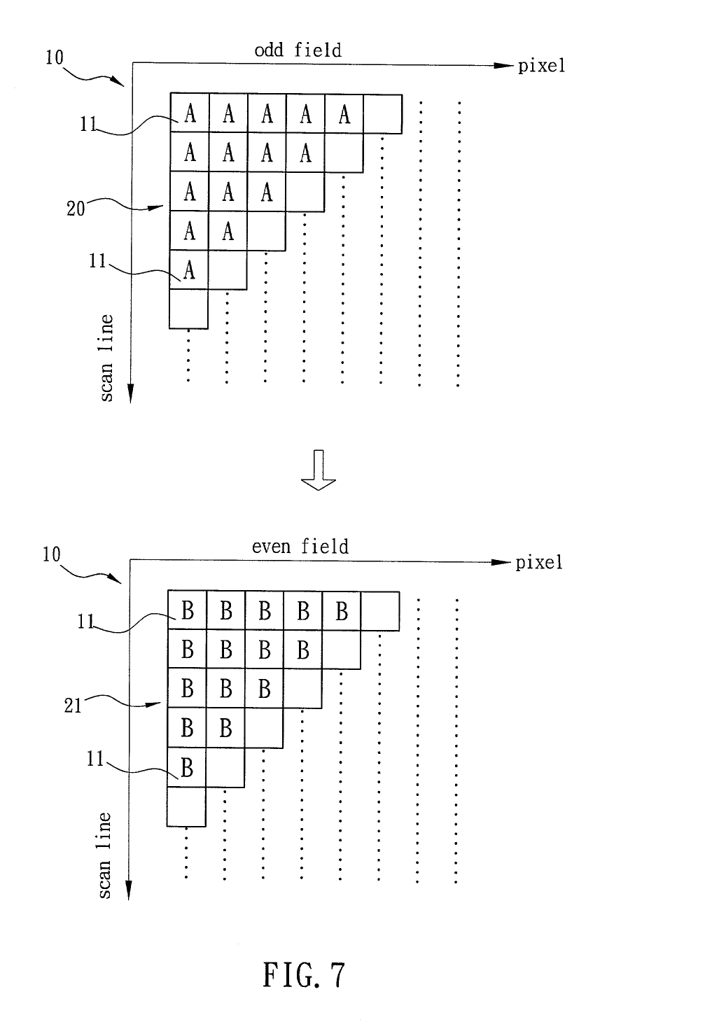

Referring to FIG. 7, the first preferred embodiment of the invention will now be described. In showing dynamic image of each of continuous fields 20 and 21 on PDP 10 each discharge unit 11 generates the same input value of gray scale corresponding to each of continuous fields 20 and 21. The input values of gray scale are converted into corresponding different visual concentration series A and B both having the same value of gray scale via visual concentration conversion table. Hence, discharge unit 11 corresponding to each sub-field of each of fields 20 and 21 may show the same gray scale based on the number of sustain pulses corresponding to value of gray scale of different visual concentration series A and B.

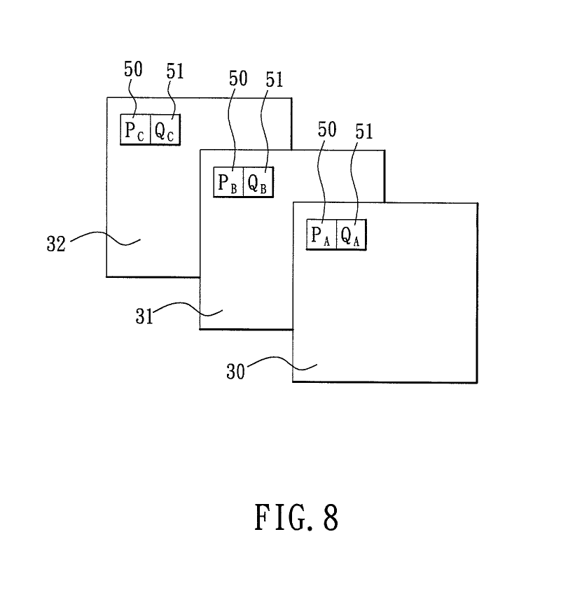

Referring to FIG. 8, when visual concentration difference between different values of gray scale P and Q shown by two adjacent discharge units 50 and 51 on continuous fields 30, 31 and 32 is too large (i.e., larger than a predetermined value), responsively, in the process of showing each of the continuous dynamic fields 30, 31 and 32 visual concentration conversion table is utilized to convert each of input values of gray scale P and Q into the same values of gray scale P_{A}, P_{B}, P_{C} and Q_{A}, Q_{B}, Q_{C} of different visual concentration series. Hence, in showing each of fields 30, 31 and 32 as to the different values of gray scale P_{A}, P_{B}, P_{C} and Q_{A}, Q_{B}, Q_{C} shown by two adjacent discharge units 50 and 51, the visual concentration thereof can be averaged to obtain one having smaller visual concentration difference. As such, it is possible of substantially eliminating dynamic false contour on PDP caused by undesired large visual concentration difference of values of gray scale P and Q of two adjacent discharge units 50 and 51.

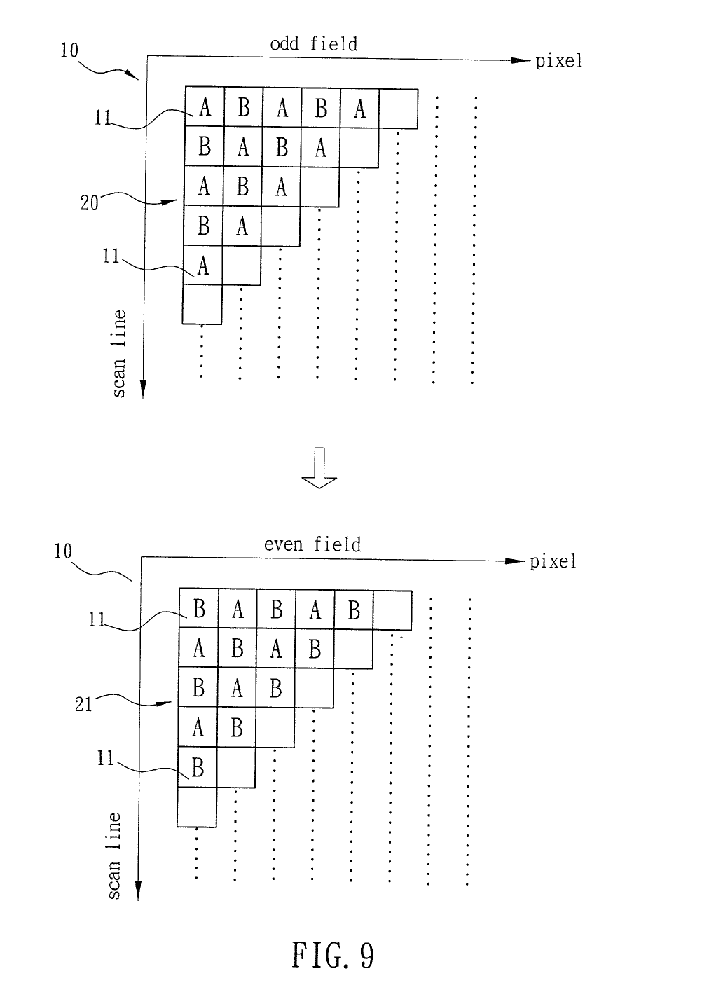

Referring to FIG. 9, the second preferred embodiment of the invention will now be described. In showing dynamic image of each of continuous fields 20 and 21 on PDP 10 each discharge unit 11 generates the same input value of gray scale corresponding to each of continuous fields 20 and 21. The input values of gray scale are converted into corresponding different visual concentration series A and B both having the same value of gray scale via visual concentration conversion table. In an alternate discharge unit 11 of each of fields 20 and 21, values of gray scale of different visual concentration series A and B are shown. In a corresponding discharge unit 11 of alternate fields 20 and 21, values of gray scale of different visual concentration series A and B are shown. Hence, discharge unit 11 corresponding to each sub-field of field 20 or 21 may show the same gray scale based on the number of sustain pulses corresponding to values of gray scale of different visual concentration series A and B. Hence, in the process of showing dynamic field as to the different values of gray scale shown by two adjacent discharge units, they are converted into different visual concentration series having the same value of gray scale by visual concentration conversion table. As such, in continuously showing each field the visual concentration of the shown different value of gray scale on two adjacent discharge units can be averaged to obtain one having smaller visual concentration difference.

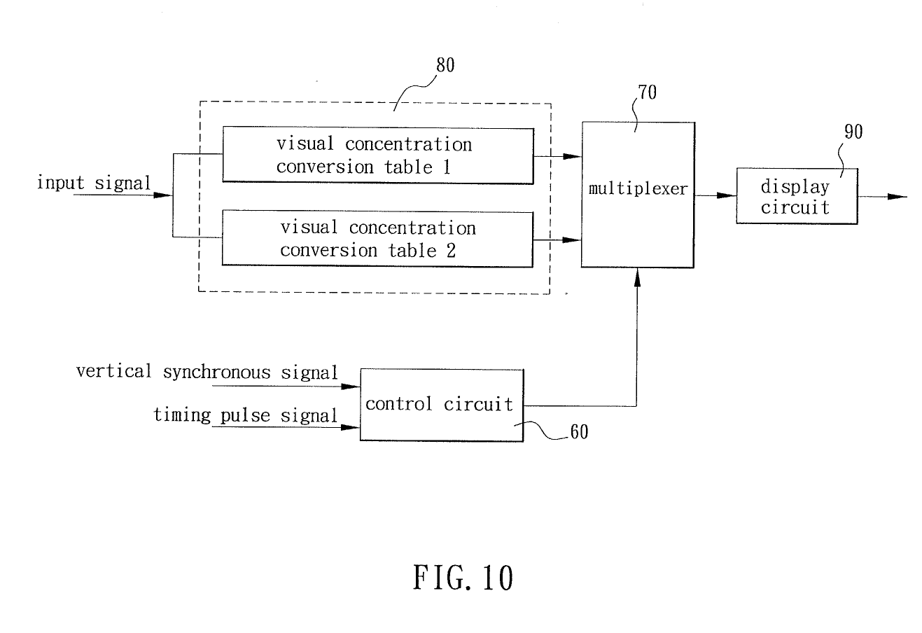

For implementing above preferred embodiments, the invention use a multiplexer 70 as a data selector in showing dynamic image on PDP as shown in FIG. 10. The multiplexer 70 acts to determine the current output field based on vertical synchronous signals and timing pulse signals received by control circuit 60. The multiplexer 70 also selects a corresponding field from multiple sets of input fields of different visual concentration series generated by visual concentration conversion table in a conversion circuit 80. Next, the multiplexer 70 outputs the selected one to display circuit 90 for driving each of discharge units. Thereafter, fields are shown on PDP. As an end, in showing continuous field on PDP visual concentration of different values of gray scale shown by any two of adjacent discharge units can be averaged to obtain one having smaller visual concentration difference, resulting in a much elimination of the undesired dynamic false contour caused by large visual concentration difference.

While the invention herein disclosed has been described by means of specific embodiments, numerous modifications and variations could be made thereto by those skilled in the art without departing from the scope and spirit of the invention set forth in the claims.

What is claimed is:

1. A method for reducing dynamic false contour in a plasma display panel (PDP) comprising the steps of:
selecting some gray scales of different visual concentration series from all of gray scales available to be shown on said PDP to form a visual concentration conversion table;
converting original input value of gray scale of each discharge unit into corresponding selected gray scales of different visual concentration series via said conversion table while showing each field of a dynamic image on said PDP; and
showing said converted gray scales on corresponding discharge units corresponding to each sub-field of each field;
wherein said some gray scales are selected to show the same value of gray scale based on the number of sustain pulses corresponding to values of gray scales of different visual concentration series.

2. The method of claim 1, wherein after the input value of gray scale has been converted into the different visual concentration series having the same value of gray scale by the visual concentration conversion table, the value of gray scale of the different visual concentration series is shown on the corresponding discharge unit of the continuous field so that the discharge unit corresponding to each sub-field of each field is operative to show the same gray scale based on the number of sustain pulses corresponding to the values of gray scale of the different visual concentration series.

3. The method of claim 1, wherein after the input value of gray scale has been converted into the different visual concentration series having the same value of gray scale by the visual concentration conversion table, the value of gray scale of the different visual concentration series is shown on the alternate discharge unit of each field and the corresponding discharge unit of the alternate field respectively so that the discharge unit corresponding to each sub-field of each field is operative to show the same gray scale based on the number of sustain pulses corresponding to the values of gray scale of the different visual concentration series.

4. An apparatus for reducing dynamic false contour in a plasma display panel (PDP) having a plurality of discharge units, the apparatus comprising:
a conversion circuit having a visual concentration conversion table so that the conversion circuit is operable to identify a value of gray scale of each discharge unit when receives an input field signal, convert the value of gray scale of each discharge unit into a plurality of sets of the different visual concentration series having the same value of gray scale by the visual concentration conversion table;
a control circuit for receiving vertical synchronous signals and timing pulse signals; and
a multiplexer coupled to the conversion circuit and the control circuit, the multiplexer being operable to determine a current output field based on the signals sent from the control circuit, selecting a corresponding field from a plurality of sets of input fields generated by the conversion circuit, and output the selected field to a display circuit for driving each discharge unit, whereby when the fields are continuously shown on the PDP a visual concentration of different values of gray scale shown by any two of the adjacent discharge units is averaged to obtain ones having smaller visual concentration difference.
